(19) United States
(12) Patent Application Publication
(10) Pub. No.: US 2012/0154207 A1
(43) Pub. Date: Jun. 21, 2012

(54) APPARATUS AND METHOD FOR SCANNING IMAGE IN IMAGE PROCESSING SYSTEM

(75) Inventors: Kwang-Seon Kim, Daejeon (KR); Bong-Su Kim, Daejeon (KR); Min-Soo Kang, Daejeon (KR); Woo-Jin Byun, Daejeon (KR)

(73) Assignee: ELECTRONICS AND TELECOMMUNICATIONS RESEARCH INSTITUTE, Daejeon (KR)

(21) Appl. No.: 13/333,250

(22) Filed: Dec. 21, 2011

(30) Foreign Application Priority Data
Dec. 21, 2010 (KR) 10-2010-0131683
May 12, 2011 (KR) 10-2011-0044680

(51) Int. Cl. G01S 13/89

(52) U.S. Cl. 342/179

(57) ABSTRACT

Disclosed is an image scanning apparatus in an image processing system, including: a frequency signal generator configured to synthesize at least two single frequency signals; a frequency up converter configured to up-convert and transmit the synthesized single frequency signals; a frequency down converter configured to down-convert and receive frequency signals reflected from an object by the up-converted frequency signals; a frequency sorter configured to sort the down-converted frequency signals so as to correspond to the at least two single frequency signals; a multiple frequency processor configured to generate a transfer function by performing parallel processing on each of the sorted frequency signals; and an image processing unit configured to generate an image of the object by using the transfer function.

### CROSS-REFERENCE TO RELATED APPLICATIONS

The present application claims priority of Korean Patent Application Nos. 10-2010-0131683 and 10-2011-0044680, filed on Dec. 21, 2010 and May 12, 2011, respectively, which are incorporated herein by reference in their entireties.

### BACKGROUND OF THE INVENTION

1. Field of the Invention

Exemplary embodiments of the present invention relate to an image processing system, and more particularly, to an apparatus and a method for scanning an image capable of reducing time consumed to capture an image using a multiple frequency in an image processing system.

2. Description of Related Art

An image processing system means a system that processes objects, such as persons, animals, matters, or the like, in a visualized image type. For example, the image processing system may be used for various fields such as a hazardous material search, a weapon search for security, personal avatar generation for fitting clothes, or the like, in an airport, a cargo terminal, or the like.

The present image processing system generates an image by black body radiation of an object and thus, leads to deteriorate resolution. In order to obtain higher resolution than the image processing system processing an image by a manual manner such as the black body radiation, or the like, an image processing system using an active manner has been proposed. However, even the image processing system using the active manner needs a broadband so as to acquire high resolution. However, the image processing system has a problem that a scanning speed is reduced in order to use the broadband.

### SUMMARY OF THE INVENTION

An embodiment of the present invention is directed to an apparatus and a method for scanning an image in an image processing system.

Another embodiment of the present invention is directed to provide an apparatus and a method for scanning an image capable of reducing time consumed to scan an image in an image processing system.

Another embodiment of the present invention is directed to provide an apparatus and a method for scanning an image capable of reducing time consumed to scan an image in an image processing system.

In accordance with an embodiment of the present invention, there is provided an image scanning apparatus in an image processing system, including: a frequency signal generator configured to synthesize at least two single frequency signals; a frequency up converter configured to up-convert and transmit the synthesized single frequency signals; a frequency down converter configured to down-convert and receive frequency signals reflected from an object by the up-converted frequency signals; a frequency sorter configured to sort the down-converted frequency signals so as to correspond to the at least two single frequency signals; a multiple frequency processor configured to generate a transfer function by performing parallel processing on each of the sorted frequency signals; and an image processing unit configured to generate an image of the object by using the transfer function.

In accordance with another embodiment of the present invention, there is provided an image scanning method in an image processing system, including: generating at least single frequencies; synthesizing the least two single frequency signals; up-converting the synthesized single frequency signals; transmitting the up-converted frequency signals; receiving frequency signals reflected from an object by the up frequency signals; down-converting the received frequency signal; sorting the down-converted frequency signals so as to correspond to the at least two single frequency signals; and generating an image by performing parallel processing on the sorted frequency signals.

### BRIEF DESCRIPTION OF THE DRAWINGS

FIG. 1 is a diagram schematically illustrating a structure of an image scanning apparatus in an image processing system in accordance with an embodiment of the present invention.

FIG. 2 is a diagram schematically illustrating a structure of a frequency signal generator in the image processing system in accordance with the embodiment of the present invention.

FIG. 3 is a diagram schematically illustrating a structure of a frequency sorter in accordance with the embodiment of the present invention.

FIG. 4 is a diagram schematically illustrating a structure of another frequency signal generator in the image processing system in accordance with the embodiment of the present invention.

FIG. 5 is a diagram schematically illustrating a structure of another frequency sorter in the image processing system in accordance with the embodiment of the present invention.

FIG. 6 is a diagram schematically illustrating a structure of another image scanning apparatus in the image processing system in accordance with the embodiment of the present invention.

FIG. 7 is a diagram schematically illustrating an image scanning process of an image processing apparatus in the image processing system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention propose an apparatus and a method for scanning an image in an image processing system. In this case, the exemplary embodiments of the present invention propose an apparatus and a method for scanning an image capable of reducing time consumed to scan an image by simultaneously transmitting and receiving multiple frequency signals having different bands in an image processing system and performing parallel processing on the multiple frequency signals and capturing the image in real time by reducing the time consumed to scan the image.

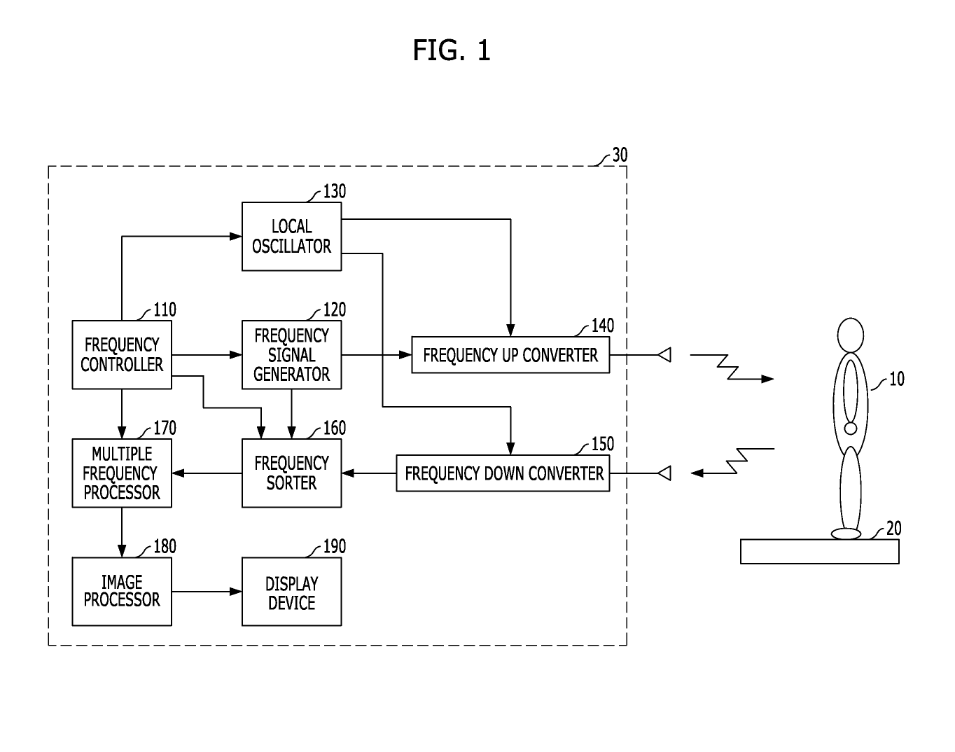

For convenience of explanation, the exemplary embodiments of the present invention as described below describe, by way of example, the case in which the image processing system in accordance with the exemplary embodiments of the present invention uses a microwave signal for scanning an image for an object. In this case, the microwave signal has a frequency of 300 MHz to 3000 GHz and includes a millimeter wave having a wavelength of millimeter unit and a centimeter wave having a wavelength in a centimeter unit. In other words, the image scanning apparatus in the image processing system according to the exemplary embodiments of the present invention scans the image by using the microwave signal. Hereinafter, an image scanning apparatus in an image processing system in accordance with exemplary embodiments of the present invention will be described in more detail with reference to FIG. 1.

FIG. 1 is a diagram schematically illustrating a structure of an image processing apparatus in an image processing system in accordance with the embodiment of the present invention.

Referring to FIG. 1, the image processing system is configured to include an object 10, a measuring board 20, and an image scanning apparatus 30. The object 10 may be a person, an animal, a matter, or the like, that are an object to be image-scanned. In addition, the measuring board 20 is a support on which an object to be image-scanned is put.

The image scanning apparatus 30 is configured to include a frequency controller 110, a frequency signal generator 120, a local oscillator 130, a frequency up converter 140, a frequency down converter 150, a frequency sorter 160, a multiple frequency processor 170, an image processor 180, and a display device 190.

The frequency controller 110 generally controls a frequency depending on the transmission and reception of a frequency signal of the image scanning apparatus 10.

The frequency signal generator 120 generates at least two single frequencies by a control of the frequency controller 110. Further, the frequency signal generator 120 generates the single frequencies so that each frequency has different frequencies and may have, for example, a microwave band. Here, the frequency signal generator 120 synthesizes the single frequencies so as to transmit the single frequency signals and outputs the synthesized single frequency signals to the frequency up converter 140. In addition, the frequency signal generator 120 may output the single frequency signals to the frequency sorter 160 for performing parallel processing the received signals.

The local oscillator 130 generates a local oscillator signal by the control of the frequency controller 110. In addition, the local oscillator 130 provides the local oscillator signal for frequency up conversion to the frequency up converter 140 and the frequency down converter 150. Further, the local oscillator 130 provides the local oscillator signal having the same phase and magnitude to each of the frequency up converter 140 and the frequency down converter 150. Therefore, the local oscillator 130 may prevent the reduction in receiving performance due to an effect of the local oscillator depending on the up conversion or the down conversion. That is, the local oscillator 130 makes the receiving characteristics of the frequency signal excellent. In this case, the local oscillator 130 may also be included in the frequency up converter 140 and the frequency down converter 150.

The frequency up converter 140 receives the synthesized frequency signal. Further, the frequency down converter 150 receives the local oscillator signal from the local oscillator 130. The frequency up converter 140 up-converts the synthesized single frequency signals by being mixed with the local oscillator signal. The up-converted frequency signal may have a radio frequency (RF) signal type. Here, the frequency up converter 140 includes a transmitter antenna for transmitting the up-converted frequency signal. Further, the frequency up converter 140 transmits the up-converted frequency signal to the object through the transmitter antenna.

The frequency down converter 150 receives the frequency signal reflected from the object 20 by the up-converted frequency signal. Here, the frequency down converter 150 may include a receiver antenna for receiving the reflected frequency signal. In addition, the frequency down converter may receive the reflected frequency signal through the receiver antenna. Here, the reflected frequency signal includes frequency signals corresponding to the single frequencies having a plurality of frequency bands.

The frequency down converter 150 receives the local oscillator signal from the local oscillator 130. The frequency down converter 150 down-converts the frequency signals reflected through the mixing of the reflected frequency signals and the local oscillation signal. The frequency down converter 150 outputs the down-converted frequency signal to the frequency sorter 160.

Here, the frequency up converter 140 and the frequency down converter 150 may share the transmitter antenna and the receiver antenna and separately use the transmitter antenna and the receiver antenna. The frequency up converter 140 and the frequency down converter 150 may also switch each of the plurality of antennas for transmitting and receiving the frequency signal, which are arranged at a predetermined interval. Further, the frequency up converter 140 and the frequency down converter 150 may move the position of the antenna to transmit and receive the frequency signal.

The frequency sorter 160 sorts the down-converted frequency signal so as to correspond to at least two single frequency signals. Further, the frequency sorter 160 converts the sorted frequency signals into a digital type. The frequency sorter 160 outputs the sorted frequency signals to the multiple frequency processor 170.

The multiple frequency processor 170 generates a transfer function by performing the parallel processing on each of the sorted frequency signals. Here, the multiple frequency processor 170 compares with the single frequency signal provided from the frequency controller 110 to calculate the transfer functions for the phase and magnitude of each frequency in parallel. Further, the multiple frequency processor 170 outputs the transfer functions to the image processor 180.

The image processor 180 generates the image using the transfer functions. Further, the image processor 180 uses the transfer functions to generate the image for the scanned object 20, that is, an image. The image processor 180 outputs the generated image to the display device 190.

Here, the generated image may be a two-dimensional or three-dimensional image.

The display device 190 displays the image. Here, the displayed image is an image for a shape of the object 10. In this case, the display device 190 may have a function of displaying the two-dimensional or three-dimensional image so as to display the provided image.

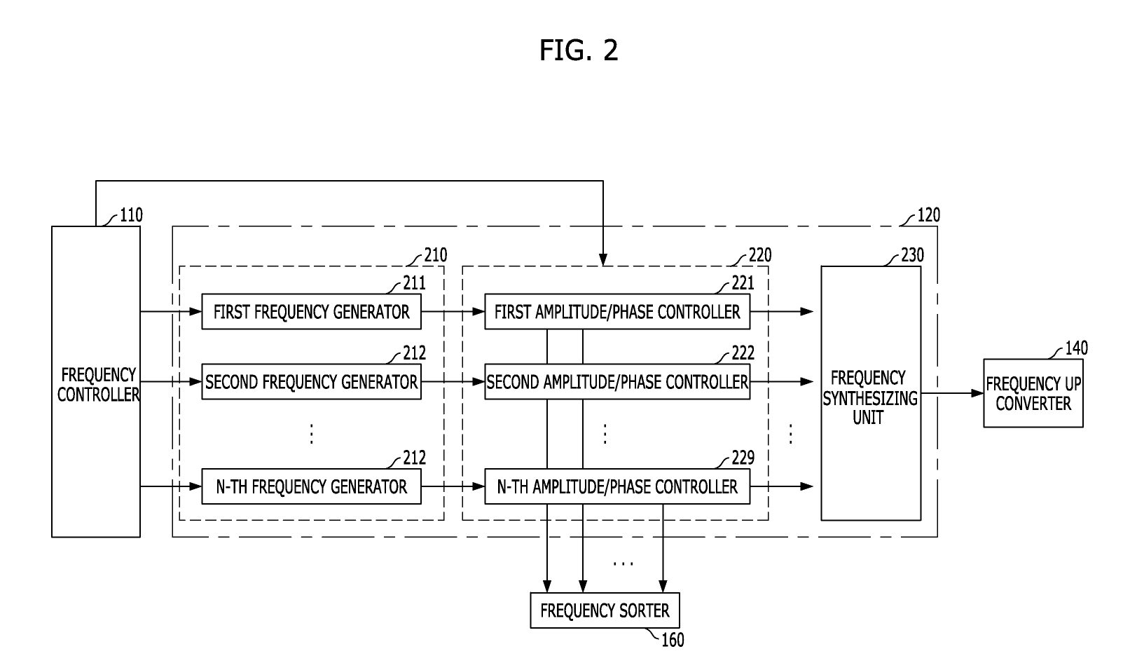

The image scanning apparatus 10 in accordance with the embodiment of the present invention simultaneously transmits and receives the plurality of frequency signals (that is, multiple frequency signals) at the time of generating the image and reducing the time consumed to scan the image by performing the parallel processing on the plurality of frequency signals. The image scanning apparatus 30 may scan the object 20 in real time by reducing the time consumed to scan the image. Hereinafter, a frequency signal generator in the image processing system in accordance with exemplary embodiments of the present invention will be described in more detail with reference to FIG. 2.

FIG. 2 is a diagram schematically illustrating a structure of a frequency signal generator in the image processing system in accordance with the embodiment of the present invention.

Referring to FIG. 2, the frequency signal generator 120 is configured to include a frequency generation unit 210, an amplitude phase control unit 220, and a frequency synthesizing unit 230.

The frequency generation unit 210 is configured to include a first frequency generator 211, a second frequency generator 212, and an n-th frequency generator 219 for generating each of the single frequencies. The frequency generation unit 210 may generate at least two single frequency signals and generate at least two single frequency signals for performing the parallel processing at the time of the image scanning.

Each of the first frequency generator 211 to the n-th frequency generator 210 generates the single frequency signals having different bands according to the control of the frequency controller 110. In this case, the frequency controller 110 may control the single frequency band or the number of single frequencies that are to be generated according to the necessary resolution based on the size and shape of the object to be scanned. Therefore, each of the frequency signals generated from the first frequency generator 211 to the n-th frequency generator 219 becomes the single frequency signals. Further, the first frequency generator 211 to the n-th frequency generator 219 may be configured to have the oscillator shape that generates the frequency signal. In this case, the frequency controller 110 may generate the frequency signal through a turn-on/off operation of the frequency generator 211. Further, the first frequency generator 211 to the n-th frequency generator 219 output at least two single frequency signals to the amplitude phase control unit.

The amplitude/phase control unit 220 is configured to include a first amplitude/phase controller 221, a second amplitude/phase controller 222, and an n-th amplitude/phase controller 229 for controlling at least one of the amplitude and phase of each of the single frequency signals.

The first amplitude/phase controller 221 to the n-th amplitude/phase controller 229 control at least one of the amplitude and phase of each of the single frequency signals. Further, the first amplitude/phase controller 221 to the n-th amplitude/phase controller 229 may reduce the errors according to the object scanning by controlling the amplitude and phase and may improve the non-linear problem of the amplifier due to the frequency signals having the same phase. Further, the first amplitude/phase controller 221 to the n-th amplitude/phase controller 229 output the single frequency signals of which the amplitude and phase are controlled to the frequency synthesizing unit 230 and the frequency sorter 160.

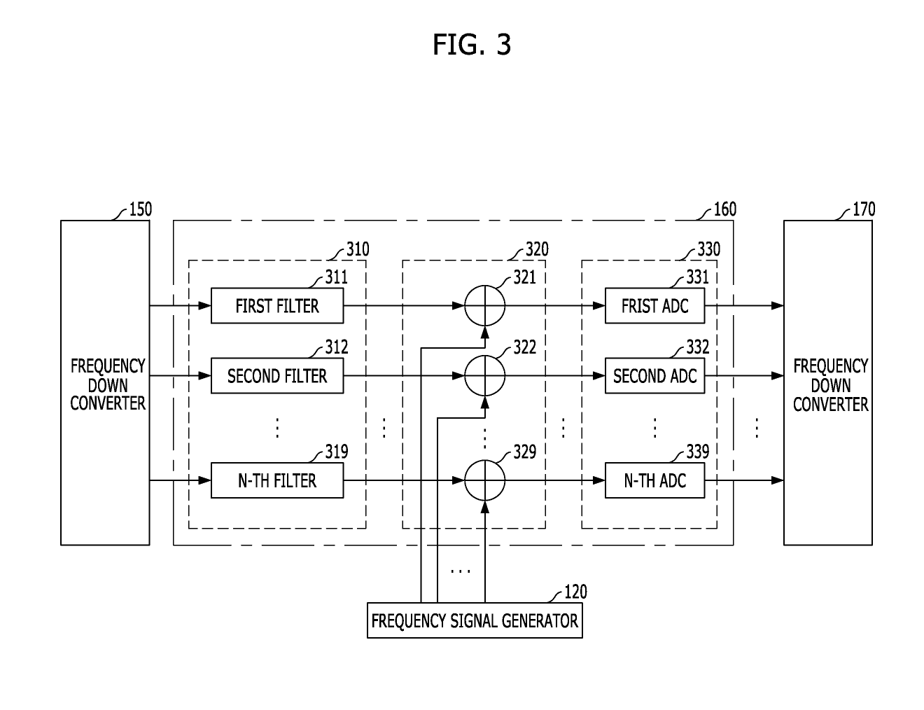

The frequency synthesizing unit 230 synthesizes the single frequency signals of which the amplitude and phase are controlled. The synthesized frequency signal is a signal transmitted for the image scanning of the object and includes the single frequency signals corresponding to the plurality of frequency bands. The frequency synthesizing unit 230 outputs the synthesized frequency signal to the frequency up converter 140. Hereinafter, the frequency sorter in the image processing system in accordance with exemplary embodiments of the present invention will be described in more detail with reference to FIG. 3.

FIG. 3 is a diagram schematically illustrating a structure of the frequency sorter in the image processing system accordance with the embodiment of the present invention.

Referring to FIG. 3, the frequency sorter 160 is configured to include a filter unit 310, a mixing unit 320, and an analog to digital conversion unit 330.

The filter unit 310 is configured to include a first filter 311, a second filter 312, and an n-th filter 313 for filtering the down frequency signal. In this configuration, the filter unit 310 filters each of the frequency signals corresponding to the single frequencies at the time of transmission from the down frequency signal.

In particular, the first filter 311 to the n-th filter 319 each filter different frequency bands. Further, the first filter 311 to the n-th filter 319 filter the down frequency signals. Further, the first filter 311 to the n-th filter 319 each output the filtered frequency signals to the mixing unit 320.

The mixing unit 320 is configured to include a first mixer 321, a second mixer 322, and an n-th mixer 323 for mixing the filtered frequency signals with the frequency signals output from the frequency signal generator 120.

The first mixer 321 to the n-th mixer 329 mix each of the filtered frequency signals with each of the single frequency signals of which at least one of the amplitude and phase is controlled, with the single frequency signals being output from the frequency signal generator 120. The first mixer 321 to the n-th mixer 329 output the mixed frequency signals to the analog to digital conversion unit 330.

The analog to digital conversion unit 330 is configured to include a first analog to digital converter (ADC) 331, a second analog to digital converter 332, and an n-th analog to digital converter 339 for converting the sorted frequency signals mixed with the single frequency signals into the digital signals.

Here, the first analog to digital converter 331 to the n-th analog to digital converter 339 convert each of the mixed frequency signals into the digital signals.

Further, the first analog to digital converter 331 outputs the frequency signals converted into the digital signals to the multiple frequency processor 170.

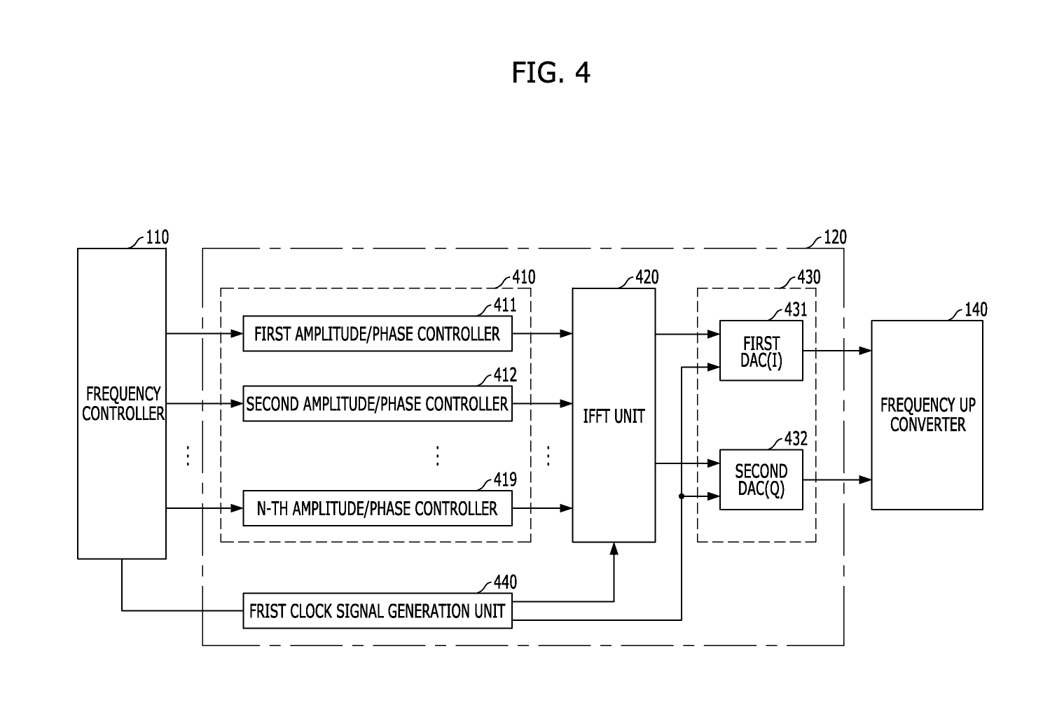

Meanwhile, the frequency sorter 160 may further include a plurality of low pass filters between the mixing unit 320 and the analog to digital conversion unit 330. In this case, the sorted frequency signals mixed in the mixing unit 320 may be filtered by each of the low pass filters and may be provided to the analog to digital conversion unit 330. Components other than the desired frequency may be removed by the low pass filters. Hereinafter, a frequency signal generator of another example in the image processing system in accordance with exemplary embodiments of the present invention will be described in more detail with reference to FIG. 4.

FIG. 4 is a diagram schematically illustrating a structure of a frequency signal generator in the image processing system in accordance with the embodiment of the present invention.

Referring to FIG. 4, the frequency signal generator 120 is configured to include an amplitude/phase control unit 410, an inverse fast Fourier transform (hereinafter, referred to as ‘IFFT’) unit 420, a digital to analog conversion unit 430, and a first clock signal generation unit 440.

The amplitude/phase controller 410 is configured to include a first amplitude/phase controller 411, a second amplitude/phase controller 412, and an n-th amplitude/phase controller 419 for generating the single frequencies of which the amplitude and phase are controlled.

Here, the first amplitude/phase controller 411 to the n-th amplitude/phase controller 419 each generate the single frequency signals having different bands according to the control of the frequency controller 110. The frequency controller 110 may control the single frequency bands or the number of single frequencies that are to be generated according to the necessary resolution based on the size and shape of the object to be scanned. Further, the first amplitude/phase controller 411 to the n-th amplitude/phase controller 419 control at least one of the amplitude and phase of each of the single frequency signals. Further, the first amplitude/phase controller 411 to the n-th amplitude/phase controller 419 output the single frequency signals of which the amplitude and phase are controlled to the IFFT unit 420. The single frequency signals of which the amplitude and phase may have a digital type.

The IFFT unit 420 performs inverse fast Fourier transform on the single frequency signals of which the amplitude and phase are controlled. Further, the IFFT unit 420 outputs the signals subjected to the inverse fast Fourier transform to the digital to analog conversion unit 430.

The digital to analog conversion unit 430 is configured to include the first digital to analog converter 431 and the second digital to analog converter 432 for converting the signals subjected to the inverse fast Fourier transform into the analog signals.

The first digital to analog converter 431 converts the inverse fast Fourier transform signals corresponding to in-phase (I) into the analog signals. Further, the second digital to analog converter 431 converts the inverse fast Fourier transform signals corresponding to quadrature-phase (Q) into the analog signals. Here, the first digital to analog converter 431 corresponds to the in-phase (I) and the second digital to analog converter 432 corresponds to the quadrature phase (Q).

The first digital to analog converter 431 and the second digital to analog converter 432 output each of the analog converted frequency signals to the frequency up converter 140.

The first clock signal generator 440 generates a first clock signal for operating the synchronization acquisition of the IFFT unit 420 and the digital to analog conversion unit 430 according to the control of the frequency controller 110. Further, the first clock signal generation unit 440 outputs the first clock signal to the IFFT unit 420 and the digital to analog conversion unit 430.

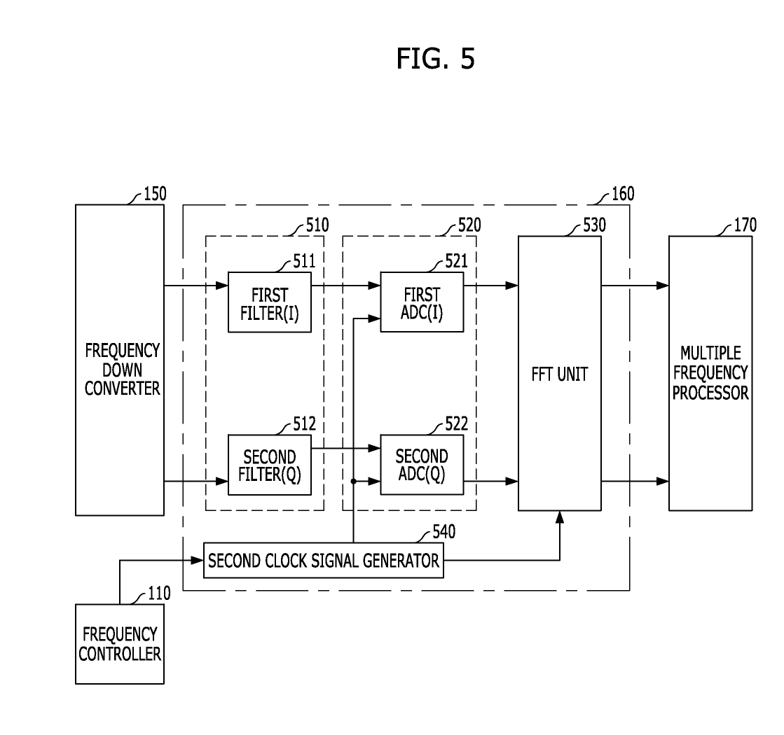

Meanwhile, the frequency up converter 140 of the image scanning apparatus 30 including the frequency signal generator 120 is configured to include an in-phase mixer and a quadrature phase mixer for up-converting the in-phase (I) signal and the quadrature phase (Q) signal. Hereinafter, a frequency sorter of another example of another example in the image processing system in accordance with exemplary embodiments of the present invention will be described in more detail with reference to FIG. 5.

FIG. 5 is a diagram schematically illustrating a structure of another frequency sorter in accordance with the embodiment of the present invention.

Referring to FIG. 5, the frequency sorter 160 is configured to include a filter unit 510, an analog to digital converter 520, a fast Fourier transform (hereinafter, referred to as ‘FFT’) unit 530, and a second clock signal generation unit 540.

The filter unit 510 is configured to include the first filter 311 and the second filter 312 for filtering the down frequency signal.

Here, the first filter 511 filters the in-phase (I) signal component from the down frequency signal. Further, the second filter 512 filters the quadrature phase (Q) signal component from the down frequency signal. The first filter 511 and the second filter 512 outputs the filtered frequency signals to the analog to digital conversion unit 520.

The analog to digital conversion unit 520 is configured to include a first analog to digital converter 521 and a second analog to digital converter 522 for converting the filtered frequency signals into the digital signals.

Here, the first analog to digital converter 521 converts the frequency signals filtered through the first filter 511 into the digital signals. Further, the second analog to digital converter 522 converts the frequency signals filtered through the second filter 512 into the digital signals. Further, the first analog to digital converter 521 corresponds to the in-phase (I) signal and the second analog to digital converter 522 corresponds to the quadrature phase (Q) signal. Further, the first analog to digital converter 521 and the second analog to digital converter 522 output the converted digital signals to the FFT unit 530.

The FFT unit 530 performs the fast Fourier transform on the converted digital signals. The FFT unit 530 outputs the signals subjected to the inverse fast Fourier transform to the multiple frequency processor 170.

The second clock signal generator 540 generates a second clock signal for operating the synchronization acquisition of the analog to digital conversion unit 520 and the FFT unit 520 according to the control of the frequency controller 110. Further, the second clock signal generation unit 540 outputs the second clock signal to the analog to digital conversion unit 520 and the FFT unit 530.

Meanwhile, the frequency down converter 140 of the image scanning apparatus 30 including the frequency signal generator 120 of FIG. 4 is configured to include the in-phase mixer and the quadrature phase mixer for up-converting the in-phase (I) signal and the quadrature phase (Q) signal.

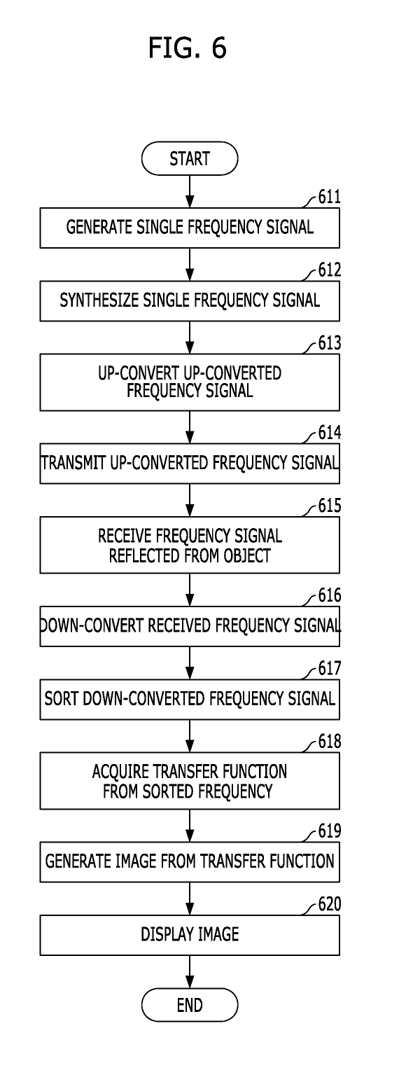

For example, the frequency signal generator 120 of FIG. 2 and the frequency sorter 160 of FIG. 3 may correspond to each other and the frequency signal generator 120 of FIG. 4 and the frequency signal generator 130 of FIG. 5 may correspond to each other. However, the frequency signal generator 120 and the frequency sorter 160 of FIGS. 2, 3, 4, and 5 may be mixed. Hereinafter, an image scanning operation of an image scanning apparatus in an image processing system in accordance with exemplary embodiments of the present invention will be described in more detail with reference to FIG. 6.

FIG. 6 is a diagram schematically illustrating an image scanning process of an image processing apparatus in the image processing system in accordance with the embodiment of the present invention.

Referring to FIG. 6, at S611, the frequency signal generator 120 generates at least two single frequencies. In this case, each of the single frequencies has different frequency bands therebetween.

Next, at S612, the frequency signal generator 120 synthesizes the single frequencies. Here, the frequency signal generator 120 outputs the single frequency signals synthesized in one to the frequency up converter 130.

In addition, the frequency signal generator 120 uses the plurality of frequency oscillators to generate the single frequencies. Thereafter, the frequency signal generator 120 controls at least one of the amplitude and phase for each of the single frequency signals to synchronize the single frequencies.

Further, the frequency signal generator 120 may generate the data of which the phase and size are controlled for the single frequency signals and may perform the inverse fast Fourier transform on the generated data. In this case, the frequency signal generator 120 may convert and transmit each of the signals subjected to the inverse fast Fourier transform into the analog signals so as to be transmitted in the wireless signal type.

Next, at S613, the frequency up converter 140 uses the local oscillator signal to up-convert the synthesized frequency signals. In this case, the local oscillator 130 may generate the local oscillation signal and output the generated local oscillator signal to the frequency up converter 140.

Further, at S614, the frequency up converter 140 transmits the up-converted frequency signal through the antenna.

Then, at S615, the frequency down converter 150 receives the up-converted frequency signals reflected from the object.

Next, at S616, the frequency down converter 150 down-converts the received frequency signals. In this case, the local oscillator 130 may generate the local oscillation signal and output the generated local oscillator signal to the frequency sorter 160.

Next, at S617, the frequency sorter 160 sorts the frequency signals into the frequency signals corresponding to at least two single frequencies. Here, the frequency sorter 160 outputs the sorted frequency signals to a multiple frequency processor 170. In this case, the frequency sorter 160 may use the plurality of filters for sorting the signals according to each of the frequency bands. Further, the frequency sorter 160 may perform the inverse fast Fourier transform on the received signals so as to separate the signals according to each of the frequency bands.

Thereafter, at S618, the multiple frequency processor 170 processes the sorted frequency signals in parallel to acquire the transfer functions. Here, the multiple frequency processor 170 outputs the acquired transfer functions to the image generation unit 180. In this case, the multiple frequency processor 170 may sort the frequency signal scanning the object 10 into each of the frequency signals corresponding to each of the frequency bands and perform the parallel processing thereon by generating and transmitting the plurality of frequency signals.

Further, at S619, the image generation unit 180 uses the transfer functions to generate the image of the object 10. The image generation unit 180 outputs the generated image to the display device 190.

Next, at S620, the display device 190 displays the image. Hereinafter, an image scanning apparatus in an image processing system in accordance with another exemplary embodiment of the present invention will be described in more detail.

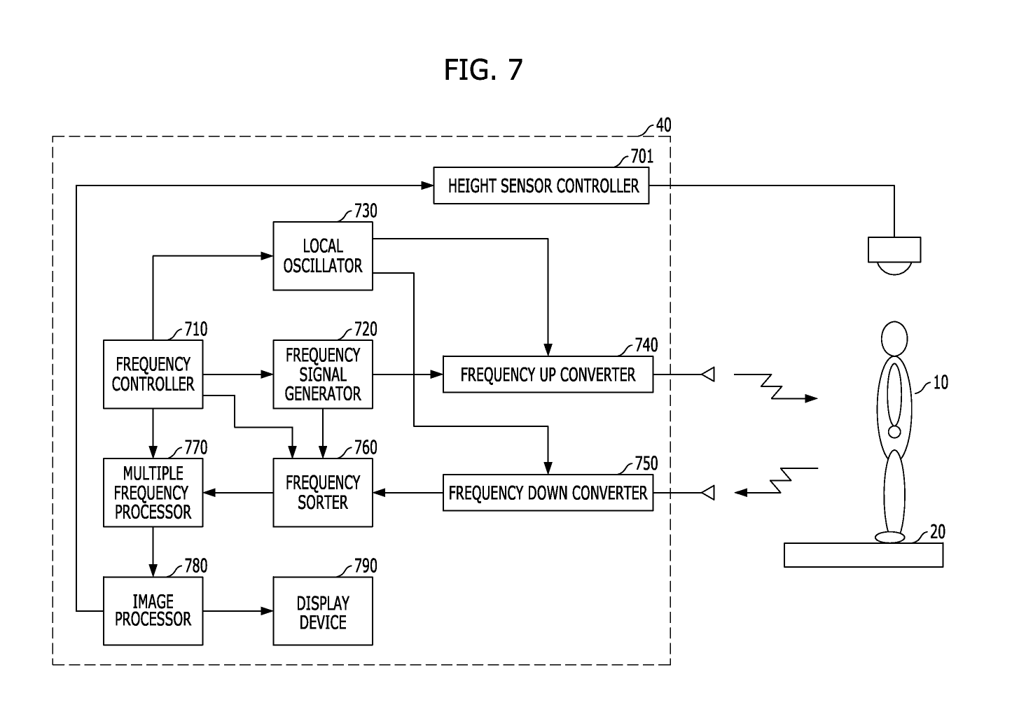

FIG. 7 is a diagram schematically illustrating a structure of an image processing apparatus in an image processing system in accordance with the embodiment of the present invention.

Referring to FIG. 7, the image processing system is configured to include the object 10, the measuring board 20, and the image scanning apparatus 40.

The image scanning apparatus 40 is configured to include a height sensor controller 701, a frequency controller 710, a frequency signal generator 720, a local oscillator 730, a frequency up converter 140, a frequency down converter 740, a frequency sorter 760, a multiple frequency processor 770, an image processor 780, and a display device 790.

Here, the structure of the image scanning apparatus 40 of FIG. 7 has a structure similar to the image scanning apparatus 30 of FIG. 1 and thus, performs the similar operation. In other words, the operation of the frequency controller 710 corresponds to the frequency controller 110, the operation of the frequency signal generator 720 corresponds to the operation of the frequency signal generator 120, and the operation of the local oscillator 730 corresponds to the operation of the local oscillator 130. In addition, the operation of the frequency up converter 740 corresponds to the operation of the frequency up converter 140, the operation of the frequency down converter 750 corresponds to the operation of the frequency down converter 150, and the operation of the frequency sorter 760 corresponds to the operation of the frequency sorter 160, and the operation of the multiple frequency processor 770 corresponds to the operation of the multiple frequency processor 770. Further, the operation of the image processor 780 corresponds to the operation of the image processor 180 and the operation of the display device 790 corresponds to the operation of the display device 790.

However, the image scanning apparatus 40 of FIG. 7 may further include the height sensor controller 701 as compared with the image scanning device 30 of FIG. 1.

Herein, the image scanning apparatus 40 can scan the image by further using the information acquired through the height sensor controller 701 as compared with the image scanning apparatus 30.

That is, the height sensor controller 701 may sense the height or the diameter of the object 10. Here, the height sensor controller 701 may include a camera, a distance measuring sensor, an infrared sensor, or the like, for measuring a height, a diameter, or the like. In addition, the height sensor controller 701 outputs the information on the sensed object 10, for example, the information such as a height, a diameter, or the like, to the image processor 780.

Meanwhile, the frequency signal generator 720 may use the frequency signal generator 120 shown in FIGS. 2 and 4 and the frequency sorter 760 may use the structure of the frequency sorter 160 shown in FIGS. 3 and 5.

The image scanning apparatuses 30 and 40 in accordance with the exemplary embodiment of the present invention as described above divide the bandwidth into several single frequencies and simultaneously transmit and receive the signals and performs the parallel processing on each of the received frequency signals, thereby reducing the time consumed to capture the image through the scanning of the object. In particular, when the sensor unit is further provided as in the image scanning apparatus 40, the image scanning apparatus 40 can scan the image having the accurate dimension.

As set forth above, the exemplary embodiments of the present invention can reduce the time consumed to scan the image by simultaneously transmitting and receiving multiple frequency signals having different bands in the image processing system and performing parallel processing on the multiple frequency signals. Further, the exemplary embodiments of the present invention can capture the image in real time by reducing the time consumed to scan the image.

While the present invention has been described with respect to the specific embodiments, it will be apparent to those skilled in the art that various changes and modifications may be made without departing from the spirit and scope of the invention as defined in the following claims.

What is claimed is:

1. An image scanning apparatus in an image processing system, comprising:
a frequency signal generator configured to synthesize at least two single frequency signals;
a frequency up converter configured to up-convert and transmit the synthesized single frequency signals;
a frequency down converter configured to down-convert and receive frequency signals reflected from an object by the up-converted frequency signals;
a frequency sorter configured to sort the down-converted frequency signals so as to correspond to the at least two single frequency signals;
a multiple frequency processor configured to generate a transfer function by performing parallel processing on each of the sorted frequency signals; and
an image processing unit configured to generate an image of the object by using the transfer function.

2. The image scanning apparatus of claim 1, further comprising: a local oscillator configured to output a local oscillation signal to each of the frequency up converter and the frequency down converter for the frequency up conversion and the frequency down conversion.

3. The image scanning apparatus of claim 1, wherein the frequency generator includes:
a frequency generation unit configured to generate the at least two single frequency signals;
an amplitude/phase control unit configured to control at least one of an amplitude and a phase of each of the at least two single frequency signals; and
a synthesis frequency signal generation unit configured to synthesize the single frequency signals of which at least one of the amplitude and phase is controlled.

4. The image scanning apparatus of claim 3, wherein the frequency sorter includes:
a filter unit configured to filter the down frequency signal so as to correspond to the at least two single frequency signals;
a mixing unit configured to mix each of the single frequency signals of which at least one of the amplitude and phase is controlled with each of the filtered frequency signals; and
an analog to digital conversion unit configured to convert the mixed frequency signals into digital signals.

5. The image scanning apparatus of claim 1, wherein the frequency generator includes:
an amplitude/phase control unit configured to generate the at least two single frequency signals by a control of at least on of the amplitude and phase;
an inverse fast Fourier conversion unit configured to perform inverse fast Fourier transform on the at least two single frequency signals;
a digital to analog conversion unit configured to convert the signals subjected to the inverse fast Fourier transform into analog signals corresponding to each of the in-phase (I) and quadrature phase (Q); and
a first clock signal generation unit configured to provide a first clock signal for synchronization acquisition according to signal conversion in the inverse fast Fourier conversion unit and the digital to analog conversion unit.

6. The image scanning apparatus of claim 1, wherein the frequency sorter includes:
a filter unit configured to filter the down-converted frequency signals into signals corresponding to each of the in-phase and quadrature phase;
an analog to digital conversion unit configured to convert each of the filtered signals into digital signals;
an fast Fourier conversion unit configured to perform the fast Fourier transform on each of the signals converted into the digital signals; and
a second clock signal generation unit configured to provide a second clock signal for synchronization acquisition according to signal conversion in the analog to digital conversion unit and the fast Fourier conversion unit.

7. The image scanning apparatus of claim 1, wherein the frequency up converter includes a transmitter antenna transmitting the up frequency signal.

8. The image scanning apparatus of claim 1, wherein the frequency down converter includes a receiver antenna transmitting the down frequency signal.

9. The image scanning apparatus of claim 1, further comprising: a display device configured to display the image.

10. The image scanning apparatus of claim 1, wherein the at least two single frequencies are a frequency signal in a microwave band.

11. The image scanning apparatus of claim 1, further comprising: a sensor unit configured to acquire at least one information of a height and a diameter of the object and provide the acquired information to the image processing unit.

12. The image scanning apparatus of claim 11, wherein the image processing unit generates the image by using the information acquired by the sensor unit.

13. An image scanning method in an image processing system, comprising:
generating at least single frequencies;
synthesizing the least two single frequency signals;
up-converting the synthesized single frequency signals;
transmitting the up-converted frequency signals;
receiving frequency signals reflected from an object by the up frequency signals;
down-converting the received frequency signal;
sorting the down-converted frequency signals so as to correspond to the at least two single frequency signals; and
generating an image by performing parallel processing on the sorted frequency signals.

14. The method of claim 13, wherein the synthesizing includes:
controlling at least one of an amplitude and a phase of each of the at least two single frequency signals; and
synthesizing the single frequency signals of which at least one of the amplitude and phase is controlled.

15. The method of claim 14, wherein the sorting includes:
filtering the down-converted frequency signals so as to correspond to the at least two single frequency signals;
mixing each of the filtered frequency signals with each of the single frequency signals of which at lease one of the amplitude and phase are controlled; and
converting each of the mixed frequency signals into the digital signals.

16. The method of claim 13, wherein the synthesizing includes:
controlling at least one of the amplitude and phase of each of the at least two single frequency signals;
converting the signals subjected to a inverse fast Fourier transform into analog signals corresponding to each of the in-phase (I) and the quadrature phase (Q).

17. The method of claim 16, wherein the sorting includes:
filtering the down-converted frequency signals into signals corresponding to each of the in-phase and quadrature phase;
converting each of the signals corresponding to the in-phase and the quadrature phase into digital signals; and
performing the fast Fourier transform on the converted digital signals.

18. The method of claim 13, further comprising:
displaying the generated image.

19. The method of claim 13, wherein the at least two single frequencies are a frequency signal in a microwave band.
